(19) United States
(12) Patent Application Publication
(10) Pub. No.: US 2019/0210921 A1
(43) Pub. Date: Jul. 11, 2019

(54) ADDITIVE FOR CEMENT COMPOSITION AND CEMENT COMPOSITION

(71) Applicant: NIPPON PAPER INDUSTRIES CO., LTD., Kita-ku (JP)

(72) Inventors: Shigeki YOKOYAMA, Tokyo (JP); Ayumu TAGAMI, Tokyo (JP)

(73) Assignee: NIPPON PAPER INDUSTRIES CO., LTD., Kita-ku (JP)

(21) Appl. No.: 16/335,357

(22) PCT Filed: Sep. 12, 2017
(86) PCT No.: PCT/JP2017/032935

§ 371 Date: Mar. 21, 2019

(30) Foreign Application Priority Data
Sep. 23, 2016 (JP) 2016-185253
Sep. 23, 2016 (JP) 2016-185519

(51) Int. Cl. C04B 24/38; C04B 24/18; C04B 24/26; C04B 28/02; C04B 40/00

(52) U.S. Cl. CPC C04B 24/383; C04B 24/18; C04B 2111/34; C04B 28/02; C04B 40/0042; C04B 24/2647

(57) ABSTRACT

Provided is an additive for a cement composition capable of preparing the cement composition in which a cellulose being the additive can be uniformly dispersed into a cement matrix thereby enabling to suppress an increase in viscosity thereof, and capable of producing a cement structure having a less shrinkage strain (namely, a high reinforcing effect) and having a fine as well as homogeneous texture, and the additive for a cement composition includes powdery cellulose.

### TECHNICAL FIELD

The present invention relates to an additive for a cement composition and to a cement composition.

### BACKGROUND ART

In recent years, with an aim to enhance strength and durability of a concrete, there has been known to blend a fibrous substance at the time of preparing a cement composition. For example, in Patent Document 1, there has been proposed a composite material in which a blend of bleached cellulose obtained by bleaching the cellulose derived from various wood species with non-bleached cellulose as it is added into cement, as a fiber-reinforced composite material.

In Patent Document 2, there has been proposed a mortar composition in which a high tensile strength fiber such as a metal fiber, a carbon fiber, or an aramid fiber is added to cement. Furthermore, in Patent Document 3, it has been disclosed that strength of a cement formed body can be enhanced by using a certain admixture for cement comprising a cellulose nanofiber being a cellulose-based fiber.

### PRIOR ART DOCUMENTS

### Patent Documents

Patent Document 1: JP-A-2006-518323

Patent Document 2: JP-A-2014-019588

Patent Document 3: JP-A-2015-155357

### SUMMARY OF INVENTION

### Problem to be Solved by the Invention

Among these fibers, especially in view of economy and easy availability, it has been desired to use a cellulose-based fiber in a cement composition.

However, in the materials disclosed in Patent Documents 1 and 3, since the cellulose fibers are added into an alkaline cement composition while the form of fibers is kept, the cellulose fibers are easy to be hydrolyzed. Therefore, there is a problem that an expected reinforcing effect cannot be obtained. In addition, since it is difficult to uniformly disperse the fibers into a cement matrix and the fibers are poor compatibility with other components in the cement composition, to exhibit an increase in viscosity is easy to increase. Accordingly, there is a problem that the workability is deteriorated to cause poor operability.

Accordingly, the present invention intends to provide an additive for a cement composition capable of preparing the cement composition in which a cellulose being the additive can be uniformly dispersed into a cement matrix thereby enabling to suppress an increase in viscosity thereof, and capable of producing a cement structure having a less shrinkage strain (namely, a high reinforcing effect) and having a fine as well as homogeneous texture.

### Means for Solving Problem

The present inventors have made intensive studies with a view to solving the above problem. As a result, the present inventors have confirmed that an additive for a cement composition comprising powdery cellulose being particulate can solve the above problem, and thus the present invention can be completed.

That is, the present inventors provide the following [1] to [12]:
[1] An additive for a cement composition comprising powdery cellulose (hereinafter, it may be described as “component (B)” in the specification).
[2] The additive for a cement composition according to [1], wherein an average degree of polymerization of the powdery cellulose is 300 to 3,000.
[3] The additive for a cement composition according to [1] or [2], wherein an alkali elution rate of the powdery cellulose is 0.1 to 12.0%.
[4] The additive for a cement composition according to any one of [1] to [3], the additive comprising: a copolymer (it may be described as “component (A)” in the specification) having at least two constituent units selected from the group consisting of a constituent unit (I) derived from a monomer (it may be described as “oxyalkylene group containing unsaturated monomer” in the specification) represented by a following general formula (1), a constituent unit (II) derived from a monomer (it may be described as “carboxylic acid-containing, carboxylate salt-containing, or acid anhydride-containing unsaturated monomer” in the specification) represented by a following general formula (2), and a constituent unit (III) derived from a monomer (it may be described as “oxyalkylene group containing unsaturated monomer” in the specification) represented by a following general formula (3), and the powdery cellulose.

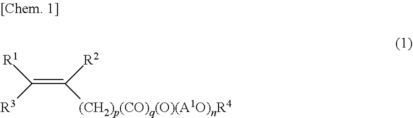

(In the general formula (1), R¹ to R³ each independently represents a hydrogen atom or an alkyl group having 1 to 3 carbon atoms. p represents an integer of 0 to 2, and q represents 0 or 1. A¹O represents identical or different oxyalkylene groups having 2 to 18 carbon atoms. n represents an integer of 1 to 300. R⁴ represents a hydrogen atom or a hydrocarbon group having 1 to 30 carbon atoms.)

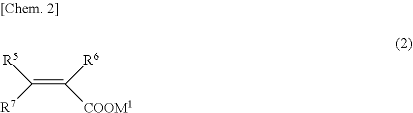

(In the general formula (2), R⁵ to R⁷ each independently represents a hydrogen atom, —CH₃, or —(CH₂)ᵣCOOM². Note that (CH₂)ᵣCOOM² may form an anhydride together with —COOM¹ or with another —(CH₂)ᵣCOOM², and when the anhydride is formed, there is no M¹ or M² present in these groups. M¹ and M² each represents identical or different a hydrogen atom, an alkali metal, an alkali earth metal, an ammonium group, an alkyl ammonium group, or a substituted alkyl ammonium group. r represents an integer of 0 to 2.)

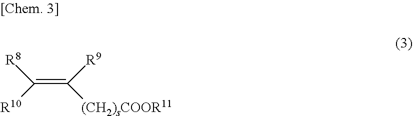

(In the general formula (3), R⁸ to R¹⁰ each independently represents a hydrogen atom or an alkyl group having 1 to 3 carbon atoms, R¹¹ represents a hydrocarbon group having 1 to 4 carbon atoms as well as optionally including a heteroatom. s represents an integer of 0 to 2.)
[5] The additive for a cement composition according to [4], wherein the copolymer is at least any one of a copolymer (AI) having the constituent unit (I) and the constituent unit (II), and a copolymer (A2) having the constituent unit (I), the constituent unit (II), and the constituent unit (III).
[6] The additive for a cement composition according to [4] or [5], wherein an addition rate of the copolymer relative to a total weight of the cement to be added is 0.01 to 5.0% by weight, and an addition rate of the powdery cellulose relative to the total weight of the cement to be added is 1 to 50% by weight.
[7] The additive for a cement composition according to any one of [1] to [6], wherein the powdery cellulose comprises powdery cellulose (B1) (hereinafter, it may be described as “component (B1)” in the specification) having an average degree of polymerization of 300 to less than 900 as well as an alkali elution rate of 5.0 to 12.0%.
[8] The additive for a cement composition according to any one of [1] to [6], wherein the powdery cellulose comprises powdery cellulose (B2) (hereinafter, it may be described as “component (B2)” in the specification) having an average degree of polymerization of 900 to 3,000 as well as an alkali elution rate of 0.1 to less than 5.0%.
[9] The additive for a cement composition according to any one of [1] to [6], wherein the powdery cellulose comprises powdery cellulose (B1) having an average degree of polymerization of 300 to less than 900 as well as an alkali elution rate of 5.0 to 12.0% and powdery cellulose (B2) having an average degree of polymerization of 900 to 3,000 as well as an alkali elution rate of 0.1 to less than 5.0%.
[10] The additive for a cement composition according to any one of [1] to [9], further comprising a sulfonic acid-based dispersant (hereinafter, it may be described as “component (S)” in the specification) and/or a retarder (hereinafter, it may be described as “component (G)” in the specification).
[11] A cement composition comprising the additive for a cement composition according to any one of [1] to [10].
[12] A residential exterior wall material using the cement composition according to [11].

### EFFECT OF THE INVENTION

According to the additive for a cement composition of the present invention, it is possible to prepare the cement composition in which powdery cellulose is uniformly dispersed into a cement matrix thereby enabling to suppress an increase in viscosity thereof, and to produce a cement structure having a less shrinkage strain (namely, a high reinforcing effect) and having a fine as well as homogeneous texture.

### EMBODIMENTS FOR CARRYING OUT THE INVENTION

Embodiments of the present invention will be explained hereinafter. Note that the embodiments to be explained hereinafter are examples of preferable embodiments of the present invention, so that the present invention is not limited to the embodiments to be explained hereinafter. In this specification, the description of “AA to BB%” or the like means “AA% or more to BB% or less” unless otherwise specifically described.

(1) Additive for Cement Composition of the Present Invention

The additive for a cement composition of the present invention includes the component (B). In addition, it is preferable that the additive for a cement composition of the present invention further includes the component (A). Further, it is more preferable that the additive for a cement composition of the present invention further includes the component (S) and/or the component (G).

(1-1) Component (B)

The additive for a cement composition of the present invention includes powdery cellulose as the component (B). Thereby, it is possible to control the hydrolysis (alkali elution rate) under an alkali condition, dispersion into the cement composition, and the like. Therefore, it is possible to provide the additive for a cement composition capable of preparing the cement composition that can suppress an increase in viscosity and producing a cement structure having a less shrinkage strain and having a fine as well as homogeneous texture.

(1-1-1) Physical Property

<Average Degree of Polymerization>

The lower limit of the average degree of polymerization of the powdery cellulose is preferably 300 or more. The upper limit thereof is preferably 3,000 or less. When the average degree of polymerization of the powdery cellulose is less than 300, it is not preferable because there is a case where the reinforcing effect to the cement structure may not be obtained. On the other hand, when the average degree of polymerization of the powdery cellulose is more than 3,000, there are cases where a viscosity of the cement composition such as a fresh concrete may increase to deteriorate the workability, and where it is difficult to obtain the cement structure having a fine and homogeneous texture. Therefore, the average degree of polymerization of the powdery cellulose is preferably 300 to 3,000. Here, when the average degree of polymerization of the powdery cellulose is in the range of 300 to less than 900, dispersion of the powdery cellulose in the cement composition is so good that the cement structure having a fine and homogeneous texture can be obtained. On the other hand, when the average degree of polymerization is 900 to 3,000, it is difficult to obtain a homogeneous texture because the texture of the powdery cellulose appears in the cement structure, but the reinforcing effect thereof can be enhanced.

Measurement method of the average degree of polymerization is not particularly limited, and the measurement may be performed by heretofore known methods. The methods include, for example, a viscosity measurement method using cupper ethylene diamine, which is described in “Guidebook of the Japanese Pharmacopoeia, 16^{th} Ed.; Crystalline Cellulose Confirmation Test (3)”, and a method of measuring an intrinsic viscosity with a fully automatic viscosity measurement system for pulp and polymer RPV-1 (manufactured by RHEOTEK, Inc.), followed by introducing the intrinsic viscosity value into the formula [η]=0.909×DP^{0.85} (formula (2) in “Viscosity Measurements of Cellulose/SO₂-Amine Dimethylsulfoxide Solution” (by Isogai, et al., 1998)).

<Intrinsic Viscosity>

The intrinsic viscosity of a diluted cellulose solution of the powdery cellulose obtained by the method in accordance with the intrinsic viscosity number measurement method (copper ethylene diamine method) specified in JIS P 8215 is preferably 100 to 1,800, more preferably 100 to 900, and further preferably 150 to 600. When the intrinsic viscosity of the diluted cellulose solution obtained by dissolving the powdery cellulose is 100 or more, the reinforcing effect to the cement structure can be obtained. On the other hand, when the intrinsic viscosity of the diluted cellulose solution obtained by dissolving the powdery cellulose is 1,800 or less, it is easy to suppress the deterioration of workability of the cement composition such as a fresh concrete, which is caused by an increase in viscosity thereof, and to obtain the cement structure having the fine as well as homogeneous texture.

<Alkali Elution Rate>

The lower limit of the alkali elution rate of the powdery cellulose is usually 0.1% or more. The upper limit thereof is preferably 12.0° or less, more preferably 7.0° or less, and further preferably 5.0° or less. When the alkali elution rate of the powdery cellulose is more than 12.0%, at the time of preparing the cement composition under an alkali condition, elution of decomposition products of the cellulose is increased. As a result, the dispersing ability to the cement composition such as a fresh concrete may be deteriorate or the reinforcing effect to the cement structure may decrease, and thus, this is not preferable. Therefore, the alkali elution rate of the powdery cellulose is preferably 0.1 to 12.0%, more preferably 0.1 to 7.0%, and further preferably 0.1 to 5.0%.

In this specification, the alkali elution rate is the value calculated from the formula B/A×100 (%). Namely, this value is calculated by substituting A, which is the dry weight of the powdery cellulose, and B, which is the dry weight of the eluted materials included in a filtrate after filtering (for 3 hours at 105° C.) the solution obtained by alkali-treatment of the powdery cellulose (the powdery cellulose is soaked in an alkali solution of pH 13 at 50° C. for 120 hours) with a 1G1 glass filter (manufactured by Tokyo Garasu Kikai Co., Ltd.). More specifically, 5 g of the powdery cellulose (dry weight A, at 105° C. for 3 hours) and 100 mL of an aqueous sodium hydroxide solution adjusted at pH of 13 are added into a mayonnaise bottle (200 mL) and they are sufficiently stirred, and then left to stand for 120 hours in a constant temperature bath controlled at 50° C. Thereafter, the dry weight B (for 3 hours at 105° C.) of the filtrate obtained by filtering the solution with a 1G1 glass filter (manufactured by Tokyo Garasu Kikai Co., Ltd.) is measured, and then the values thereof are substituted into the formula B/A×100 to calculate the alkali elution rate (%). Note that the smaller this value is, the better the alkali resistance is.

<Average Particle Diameter>

The lower limit of the average particle diameter of the powdery cellulose is preferably 10 μm or more. The upper limit thereof is preferably 90 μm or less. The larger the average particle diameter is, the higher the reinforcing effect to the cement structure is, but the workability is prone to deteriorate due to an increase in viscosity of the cement composition. On the other hand, when the average particle diameter decreases, the workability of the cement composition becomes good, but the reinforcing effect to the cement structure is prone to decrease. Therefore, the average particle diameter of the powdery cellulose is preferably 10 to 90 μm.

The measurement condition of the average particle diameter is not particularly limited. For example, the following measurement condition may be mentioned. After 0.5 g of a sample is weighed into a 100-mL beaker, 60 mL of 0.5% hexametaphosphoric acid solution is added thereto. Then, the resulting mixture is treated with an ultrasonic treatment apparatus (manufactured by Dr. Hielscher Gmbh) with the condition of 20% output power for 2 minutes to prepare the measurement sample. Thus obtained measurement sample is subjected to the measurement by using a laser diffraction type particle size distribution measurement apparatus (Mastersizer 2000, manufactured by Malvern Instruments of Spectris PLC) as the measurement apparatus. A laser scattering method is used as the measurement principle, and the particle size distribution is expressed by a cumulative particle size distribution. The value when the cumulative distribution reaches 50° is taken as the average particle diameter.

<Apparent Specific Weight>

The lower limit of the apparent specific weight of the powdery cellulose is preferably 0.1 g/cm³ or more. The upper limit thereof is preferably 0.6 g/cm³ or less. When the apparent specific weight of the powdery cellulose is in the range of 0.1 to 0.6 g/cm³, the intended effects of the present invention can be suitably obtained.

The measurement condition of the apparent specific weight is not particularly limited. For example, the following condition may be mentioned. After 10 g of a sample is weighed into a 100 mL graduated cylinder, tapping of the bottom of the graduated cylinder is continued until the height of the sample does not lower any further. And then, the scale of the flat surface is read to measure the volume per 10 g of the sample. From this measured volume, the weight per unit volume (1 cm³) is calculated to obtain the apparent specific weight. Note that the larger this value is, the more the cellulose being powdery is made compact.

<Angle of Repose>

The lower limit of the angle of repose of the powdery cellulose is preferably 45° or more. The upper limit thereof is preferably 65° or less. When the angle of repose of the powdery cellulose is 45 to 65°, the intended effects of the present invention can be suitably obtained.

The measurement condition of the angle of repose is not particularly limited. For example, the following measurement condition may be mentioned. The value of the Angle Repose obtained by measurement with a powder tester (PT-N Type; manufactured by Hosokawa Micron Corp.) is taken as the angle of repose. Here, the value of angle of repose is an index of the powder flowability, indicating that the smaller this value is, the more the powder is superior in flowability.

<Degree of Crystallinity>

The lower limit of the degree of crystallinity of the powdery cellulose is preferably 60% or more, and more preferably 65% or more. The upper limit thereof is preferably 90% or less, and more preferably 85% or less. The degree of crystallinity of the powdery cellulose is influenced mainly by a raw material pulp and a production method thereof. More specifically, the degree of crystallinity of the powdery cellulose produced only by a mechanical treatment without carrying out an acid treatment is low. When the degree of crystallinity is decreased, the reinforcing effect to the cement structure is prone to decrease. On the other hand, when the degree of crystallinity is higher than 90%, the reinforcing effect to the cement structure increases, but the cellulose is prone to be eluted due to decomposition thereof under an alkali condition. Therefore, this may be a cause of the delay in setting of the cement composition such as a fresh concrete. Accordingly, the degree of crystallinity of the powdery cellulose is preferably in the range of 60 to 90%.

The degree of crystallinity of the powdery cellulose may be obtained by measuring an X-ray diffraction of the sample. More specifically, the measurement is carried out by using the method by Segal et al. (L. Segal, J. J. Greely, et al., Text. Res. J., 29, 786, 1959) and the method by Kamide et al. (K. Kamide et al., Polymer J., 17, 909, 1985), and the degree of crystallinity can be calculated by the following formula from the diffraction strength of the 002 plane and the diffraction strength of the amorphous portion at 2θ=18.5° as the base line of the diffraction strengths in the range of 2θ=4° to 32° in the diffraction chart obtained from the X-ray diffraction measurement.

Xc=(I_{002C}−Ia)/I_{002C}×100

Xc: degree of crystallinity of the cellulose (%)

I_{002C}: diffraction strength of the 002 plane at 2θ=22.6°

Ia: diffraction strength of the amorphous portion at 2θ=18.5°

(1-1-2) Use Embodiment

The powdery cellulose may be used alone, or a combination of two or more kinds thereof.

One embodiment of the powdery cellulose includes a powdery cellulose (B1) having the average degree of polymerization in the range of 300 to less than 900 as well as the alkali elution rate of 5.0 to 12.0%. When the average degree of polymerization of the powdery cellulose is in the range of 300 to less than 900, dispersion of the powdery cellulose in the cement composition is so good that the cement structure having a fine as well as homogeneous texture can be produced.

The other embodiment of the powdery cellulose includes a powdery cellulose (B2) having the average degree of polymerization in the range of 900 to 3,000 as well as the alkali elution rate in the range of 0.1 to less than 5.0%. Here, it is preferable that the component (B2) is the powdery cellulose having average degree of polymerization of 900 to 1,800 as well as alkali elution rate in the range of 0.1 to less than 5.0%. When the average degree thereof is 900 to 3,000, it is difficult to obtain a homogeneous texture because the texture of the powdery cellulose appears in the cement structure, but the reinforcing effect thereof can be enhanced.

Still other embodiment of the powdery cellulose includes both the component (B1) and the component (B2). Namely, this is the embodiment in which a combination of two or more of the powdery cellulose is used. The embodiment using the component (B1) and the component (B2) together can be said a suitable embodiment that can express the effect of the additive for the cement composition of the present invention. That is, it is possible to prepare the cement composition in which powdery cellulose is uniformly dispersed into a cement matrix thereby enabling to suppress an increase in viscosity thereof, and to produce the cement structure having a less shrinkage strain (namely, a high reinforcing effect) as well as having a fine and homogeneous texture.

When both the component (B1) and the component (B2) are used together, the lower limit of the weight ratio of the component (B1) is preferably 0.1° or more by weight. And the upper limit thereof is preferably 40% or less by weight. The lower limit of the weight ratio of the component (B2) is preferably 60% or more by weight. And the upper limit thereof is preferably 99.9% or less by weight. Note that a total of the component (B1) and the component (B2) is 100% by weight.

Namely, the weight ratio ((B1)/(B2)) of the component (B1) to the component (B2) is preferably 0.1 to 40% by weight/60 to 99.9% by weight (total of 100% by weight). When the component (B1) and the component (B2) are used together as the powdery cellulose with the ratio in the range of 0.1 to 40% by weight/60 to 99.9% by weight, the powdery cellulose having different average degrees of polymerization are dispersed into the cement composition in a proper balance so that the reinforcing effect (improvement in shrinkage strain) to the cement structure can be exhibited more efficiently.

(1-1-3) Preparation Method

The preparation method of the powdery cellulose will be exemplified hereinafter.

In preparation of the powdery cellulose, the pulp raw material to be used is not particularly limited, and examples thereof include a pulp derived from a hardwood, a pulp derived from a softwood, a pulp derived from a linter, a pulp derived from non-wooden material, or the like. Among them, especially the pulp derived from the softwood is preferably used. The average fiber length of the pulp derived from a softwood is longer and the average fiber width of the same is wider than those of the pulp derived from the hardwood. Therefore, it is easy to obtain the powdery cellulose having a superior reinforcing property when used as a filler, and thus, this is excellent in the use as the additive for the cement composition of the present invention. The pulping method (cooking method) of the pulp derived from these wooden materials is not particularly limited. Examples thereof include the sulfite cooking method, the kraft cooking method, the soda quinone cooking method, an organosolv cooking method, or the like. Among them, the sulfite cooking method is especially preferable because the alkali elution rate thereof is small when the powdery cellulose is added to the cement composition.

<Preparation Method of the Powdery Cellulose by Way of Carrying-Out Acidic Hydrolysis Treatment>

In the case that an acidic hydrolysis treatment is carried out, the powdery cellulose is prepared by way of, for example, a preparation process of a raw material pulp slurry, an acidic hydrolysis reaction process, a neutralization and washing process, a dehydration process, a drying process, a crushing process, and a classification process. The average degree of polymerization of the powdery cellulose prepared by way of the acidic hydrolysis reaction process is prone to be small, and the degree of crystallinity thereof is prone to be high.

The pulp raw material may be used in a fluidized state or in a sheet form. When the pulp in the fluidized state from a pulp bleaching process is used as the raw material, the concentration thereof needs to be increased before it is charged into a hydrolysis reaction vessel. Therefore, it is concentrated by a dehydration machine such as a screw press or a belt filter, and then, a prescribed amount thereof is charged into the reaction vessel. In the case when a dry pulp sheet is used as the raw material, the pulp is charged into the reaction vessel after the pulp is crushed by a crusher such as a roll crusher.

Next, the dispersion solution in which the acid concentration is adjusted to 0.10 to 1.0 N as well as the pulp concentration is made to 3 to 10% by weight (as the solid component therein) is subjected to the hydrolysis treatment at the temperature of 80 to 100° C. for the period of 30 minutes to 3 hours. After the hydrolysis treatment of the pulp, the solid-liquid separation to the hydrolyzed pulp and the waste acid is carried out in the dehydration process. An alkali agent is added to the hydrolyzed pulp for neutralization, and then washed. Thereafter, the pulp is dried by a dryer, and then mechanically crushed by a crusher and classified into a prescribed size.

The acid concentration in the acidic hydrolysis treatment of the pulp is not particularly limited. Note that, it is preferable to control in the range of 0.1 to 1.0 N in view of retaining the average particle diameter, the average degree of polymerization, and the average fiber length. When the acid concentration at the time of the acidic hydrolysis treatment is less than 0.1 N, the depolymerization of the cellulose by the acid is suppressed so that the decrease in the average degree of polymerization can be diminished, but refinement thereof is prone to be very difficult. On the other hand, when the acid concentration is more than 1.0 N, depolymerization of the cellulose is proceeded as well as refinement is easy so that the powder flowability is enhanced, but the alkali elution rate is prone to increase due to the decrease in the average degree of polymerization.

<Preparation Method of the Powdery Cellulose without Carrying-Out Acidic Hydrolysis Treatment>

In the case that the acidic hydrolysis treatment is not carried out, the powdery cellulose is prepared by way of, for example, a preparation process of the raw material pulp slurry, a washing and dehydration process, a drying process, a crushing process, and a classification process. In the powdery cellulose prepared only by mechanical treatments without carrying out the acidic hydrolysis process, the average degree of polymerization is prone to be large as well as the degree of crystallinity is prone to be low.

<Drying Process>

In the drying process, the pulp slurry is dried to obtain the pulp. As the drying method, any heretofore known method may be used, and there is not particularly limited. Examples thereof include a hot-air drying, a heating drying with far infrared rays, an air supply drying, a dehumidified air drying, a spray drying, and a freeze drying. Among them, a spray drying and an air supply drying are preferable.

<Crushing Process>

In the crushing process, the dried pulp is mechanically crushed and classified. The mechanical crushing method is not particularly limited, and the crushing may be performed with any conventionally used crushing machine. Examples of the crushing machine include a vertical roller mill (manufactured by Scenion Inc.), a vertical roller mill (manufactured by Schaeffler Japan Co., Ltd.), a roller mill (manufactured by Kotobuki Engineering & Manufacturing Co., Ltd.), a VX mill (manufactured by Kurimoto Ltd.), a KVM vertical mill (manufactured by Earth Technica Co., Ltd.), and an IS mill (manufactured by IHI Plant Engineering Corp.). In the case when the powdery cellulose is prepared only by mechanical crushing using the pulp not treated with the acidic hydrolysis as the raw material, the vertical roller mill is preferably used as the crushing machine because of high pulverization ability. The biggest feature of the vertical roller mill is superior in the pulverization ability. As the reason for being superior in pulverization ability, it may be pointed out that the raw material is crushed by the compressing force applied to the raw material between the roller and the table as well as by the shearing force generated between the roller and the table.

It is also possible to mix a raw material of the powdery cellulose with other organic component and/or an inorganic component alone or with two or more of these at an arbitrary ratio, followed by crushing. Thereby, it is possible to give the powdery cellulose functionality or enhance the functionality thereof. Also, natural cellulose to be used as the raw material may be subjected to a chemical treatment so far as the average degree of polymerization thereof is not significantly decreased.

<Classification Process>

In the classification process, the average particle diameter and the like of the crushed pulp are sorted. The classification method is not particularly limited. Examples thereof include a method using a classification machine such as a cyclone and a method using a sieving machine.

(1-2) Component (A)

Usually, the additive for the cement composition of the present invention includes a copolymer. As the component (A), a (co)polymer being heretofore known as the cement dispersant may be used. Examples of such a heretofore known (co)polymer include a polymer derived from a (poly)alkylene glycol alkenyl ether monomer; a water-soluble polyalkylene glycol whose both terminals are hydrogen atoms; and a copolymer (hereinafter, it may be also described as “copolymer (A)” in this specification) having at least two structural units selected from the group consisting of a polyoxyalkylene structural unit, a polycarboxylate structural unit, and a polyester structural unit. These (co)polymers may be used singly or as a combination of two or more of them. Examples of these (co)polymers are described below.

Examples of the polymer derived from a (poly)alkylene glycol alkenyl ether monomer include (poly)ethylene glycol allyl ether, (poly)ethylene glycol methallyl ether, (poly)ethylene glycol 3-methyl-3-butenyl ether, (poly)ethylene (poly)propylene glycol allyl ether, (poly)ethylene (poly)propylene glycol methallyl ether, (poly)ethylene (poly) propylene glycol 3-methyl-3-butenyl ether, (poly)ethylene (poly)butylene glycol allyl ether, (poly)ethylene (poly)butylene glycol methallyl ether, (poly)ethylene (poly)butylene glycol 3-methyl-3-butenyl ether, methoxy (poly)ethylene glycol allyl ether, methoxy (poly)ethylene glycol methallyl ether, methoxy (poly)ethylene glycol 3-methyl-3-butenyl ether, methoxy (poly)ethylene (poly)propylene glycol allyl ether, methoxy (poly)ethylene (poly)propylene glycol methallyl ether, methoxy (poly)ethylene (poly)propylene glycol 3-methyl-3-butenyl ether, methoxy (poly)ethylene (poly)butylene glycol allyl ether, methoxy (poly)ethylene (poly)butylene glycol methallyl ether, and methoxy (poly)ethylene (poly)butylene glycol 3-methyl-3-butenyl ether.

Examples of the water-soluble polyalkylene glycol whose both terminals are hydrogen atoms include polyethylene glycol, polypropylene glycol, polyethylene polypropylene glycol, and polyethylene polybutylene glycol.

Examples of the copolymer (A) include a copolymer having at least two constituent units selected from the group consisting of a constituent unit (I) derived from a monomer represented by the following general formula (1), a constituent unit (II) derived from a monomer represented by the following general formula (2), and a constituent unit (III) derived from a monomer represented by the following general formula (3). Incidentally, in this specification “(poly)” means that constituent element or raw material described after this phrase exists singly or plural thereof exist in a state of bonding. “(Meth)allyl” means methallyl or allyl, “(meth)acrylate” means methacrylate or acrylate, and “(meth)acrylic acid” means methacrylic acid or acrylic acid.

<Constituent Unit (I)>

The constituent unit (I) is the constituent unit derived from a monomer represented by the following general formula (1).

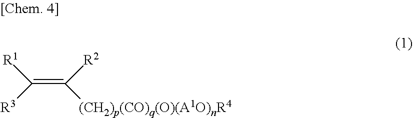

In the general formula (1), R¹ to R³ each independently represents a hydrogen atom or an alkyl group having 1 to 3 carbon atoms. Examples of the alkyl group having 1 to 3 carbon atoms include a methyl group, an ethyl group, an n-propyl group, and an isopropyl group. The alkyl group having 1 to 3 carbon atoms may have a substituent group (provided that, the carbon number in the substituent group is not included in the carbon atoms of the alkyl group). R¹ is preferably a hydrogen atom. R² is preferably a hydrogen atom or an alkyl group having 1 to 3 carbon atoms, and more preferably a hydrogen atom or a methyl group. R³ is preferably a hydrogen atom.

In the general formula (1), p represents an integer of 0 to 2. In the general formula (1), q represents 0 or 1. In the general formula (1), n represents an integer of 1 to 300.

In the general formula (1), A¹O may be identical or different oxyalkylene groups having 2 to 18 carbon atoms. Examples of the oxyalkylene group (alkylene glycol unit) include an oxyethylene group (ethylene glycol unit), an oxypropylene group (propylene glycol unit), and an oxybutylene group (butylene glycol unit). Among them, an oxyethylene group and an oxypropylene group are preferable.

In the above description, “may be identical or different” means that in the case when plural A¹O are included in the general formula (1) (that is, n is 2 or more), each A¹O may be an identical oxyalkylene group or different (two or more) oxyalkylene groups. In the embodiment in which plural A¹O are included in the general formula (1), the embodiment in which two or more of the oxyalkylene group selected from the group consisting of the oxyethylene group, the oxypropylene group, and the oxybutylene group exist as a mixture may be mentioned. More specifically, the embodiment in which the oxyethylene group and the oxypropylene group exist as a mixture, or the embodiment in which the oxyethylene group and the oxybutylene group exist as a mixture is preferable, and the embodiment in which the oxyethylene group and the oxypropylene group exist as a mixture is more preferable. In the embodiment in which different oxyalkylene groups exist as a mixture, addition of the two or more of the oxyalkylene groups may be a block addition or a random addition.

In the general formula (1), n is an average addition mole number of the oxyalkylene group, and represents an integer of 1 to 300. It is preferable that n represents 1 to 200. The average addition mole number means an average mole number of the oxyalkylene group that is added to 1 mole of the monomer.

In the general formula (1), R⁴ represents a hydrogen atom or a hydrocarbon group having 1 to 30 carbon atoms. R⁴ is preferably a hydrogen atom or a hydrocarbon group having 1 to 10 carbon atoms, more preferably a hydrogen atom or a hydrocarbon group having 1 to 5 carbon atoms, and the most preferably a hydrogen atom or a methyl group. When the number of carbon atom of R⁴ is in this range, the additive for the cement composition can be well dispersed because the number of the carbon atom thereof is not too large.

Examples of the produced method of monomer represented by the general formula (1) include a method in which 1 to 300 moles of alkylene oxides are added to an unsaturated alcohol such as allyl alcohol, methallyl alcohol, or 3-methyl-3-butene-1-ol. Examples of the monomer produced with this method include (poly)ethylene glycol allyl ether, (poly)ethylene glycol methallyl ether, (poly)ethylene glycol 3-methyl-3-butenyl ether, (poly)ethylene glycol (poly)propylene glycol (meth)allyl ether, (poly)ethylene glycol (poly)propylene glycol (meth) allyl ether, (poly)ethylene (poly)propylene glycol allyl ether, (poly)ethylene (poly)propylene glycol methallyl ether, (poly)ethylene (poly)propylene glycol 3-methyl-3-butenyl ether, (poly)ethylene (poly)butylene glycol allyl ether, (poly)ethylene (poly)butylene glycol methallyl ether, (poly)ethylene (poly)butylene glycol 3-methyl-3-butenyl ether, methoxy(poly)ethylene glycol allyl ether, methoxy (poly)ethylene glycol methallyl ether, methoxy (poly)ethylene glycol 3-methyl-3-butenyl ether, methoxy (poly)ethylene (poly)propylene glycol allyl ether, methoxy (poly)ethylene (poly)propylene glycol methallyl ether, methoxy (poly)ethylene (poly)propylene glycol 3-methyl-3-butenyl ether, methoxy (poly)ethylene (poly)butylene glycol allyl ether, methoxy (poly)ethylene (poly)butylene glycol methallyl ether, and methoxy (poly)ethylene (poly)butylene glycol 3-methyl-3-butenyl ether. Among them, in view of a balance between hydrophilicity and hydrophobicity, (poly)ethylene glycol (meth)allyl ether, (poly)ethylene glycol (poly)propylene glycol (meth) allyl ether, (poly)ethylene (poly)propylene glycol (meth)allyl ether, (poly)ethylene glycol 3-methyl-3-butenyl ether, and (poly)ethylene (poly)propylene glycol 3-methyl-3-butenyl ether are preferable.

Examples of the other produced method of the monomer represented by the general formula (1) include esterification method of an unsaturated monocarboxylic acid such as (meth)acrylate with a (poly)alkylene glycol such as (poly)ethylene glycol, (poly)ethylene (poly)propylene glycol, (poly)ethylene (poly)butylene glycol, methoxy (poly)ethylene glycol, methoxy (poly)ethylene (poly)propylene glycol, or methoxy (poly)ethylene (poly)butylene glycol. Examples of the monomer produced by this method include (poly)alkylene glycol (meth)acrylates such as (poly)ethylene glycol (meth)acrylate, (poly)ethylene (poly) propylene glycol (meth)acrylate, (poly)ethylene (poly)butylene glycol (meth)acrylate, methoxy (poly)ethylene glycol (meth)acrylate, methoxy (poly)ethylene (poly)propylene glycol (meth)acrylate, and methoxy (poly)ethylene (poly)butylene glycol (meth)acrylate. Among them, (poly)alkylene glycol (meth)acrylate and methoxy (poly)ethylene glycol (meth)acrylate are preferable, and methoxy (poly)ethylene glycol (meth)acrylate is more preferable.

When the copolymer (A) has the constituent unit (I), the copolymer may have only one constituent unit (I), or two or more constituent units (I) derived from different monomers.

<Constituent Unit (II)>

The constituent unit (II) is the constituent unit derived from the monomer represented by the general formula (2).

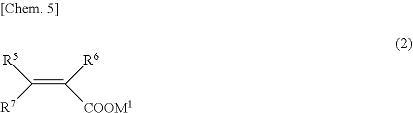

In the general formula (2), R⁵ to R⁷ each independently represents a hydrogen atom, —CH₃, or —(CH₂)ᵣCOOM². Note that, (CH₂)ᵣCOOM² may form an anhydride together with —COOM¹ or with another —(CH₂)ᵣCOOM². When the anhydride is formed, there is no M¹ or M² present in these groups. R⁵ preferably represents a hydrogen atom. R⁶ preferably represents a hydrogen atom, a methyl group, or (CH₂)₄COOM². R⁷ preferably represents a hydrogen atom.

M¹ and M² each represents identical or different a hydrogen atom, an alkali metal, an alkali earth metal, an ammonium group, an alkyl ammonium group, or a substituted alkyl ammonium group. M¹ and M² each is preferably a hydrogen atom, an alkali metal, or an alkali earth metal.

r represents an integer of 0 to 2. r is preferably 0 or 1, and more preferably 0.

Examples of the monomer represented by the general formula (2) include unsaturated monocarboxylate monomers and unsaturated dicarboxylate monomers. Specific examples of the unsaturated monocarboxylate monomer include acrylic acid, methacrylic acid, crotonic acid, as well as monovalent metal salt thereof, ammonium salt thereof, and an organic amine salt thereof. Specific examples of the unsaturated dicarboxylate include maleic acid, itaconic acid, citraconic acid, fumaric acid, as well as monovalent metal salt thereof, ammonium salt thereof, and an organic amine salt thereof, or acid anhydrides thereof. The monomer (II) is preferably acrylic acid, methacrylic acid, and maleic acid.

When the copolymer (A) includes the constituent unit (II), the copolymer may have only one constituent unit (II), or two or more constituent units (II) derived from different monomers.

<Constituent Unit (III)>

The constituent unit (III) is the constituent unit derived from the monomer represented by the general formula (3).

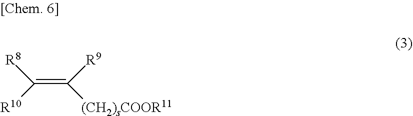

In the general formula (3), R⁸ to R¹⁰ each independently represents a hydrogen atom or an alkyl group having 1 to 3 carbon atoms. Examples of the alkyl group having 1 to 3 carbon atoms are the same as the examples of R¹ to R³. R⁸ is preferably a hydrogen atom. R⁹ is preferably a hydrogen atom. R¹⁰ is preferably a hydrogen atom.

In the general formula (3), R¹¹ represents a hydrocarbon group having 1 to 4 carbon atoms as well as optionally including a heteroatom. The number of the carbon atom is preferably 1 to 3, more preferably 2 to 3, and further preferably 3. Examples of the heteroatom include an oxygen atom, a nitrogen atom, a phosphorous atom, and a silicon atom. Among them, an oxygen atom is preferable. Examples of the hydrocarbon group having 1 to 4 carbon atoms include a methyl group, an ethyl group, an n-propyl group, an isopropyl group, a butyl group, an isobutyl group, and a sec-butyl group. The number of the heteroatom included in R¹¹ may be 1, or 2 or more. When 2 or more of the heteroatoms are included, they may be identical or different with each other.

R¹¹ is preferably the hydrocarbon group having 1 to 4 carbon atoms as well as including a heteroatom, and more preferably the hydrocarbon group having 1 to 4 carbon atoms as well as including an oxygen atom. Examples of the group include a 2-hydroxyethyl group, a 2-hydroxypropyl group, a 4-hydroxybutyl group, and a glyceryl group. Among them, a 2-hydroxyethyl group and a 2-hydroxypropyl group are preferable.

In the general formula (3), s represents an integer of 0 to 2. s is preferably 0.

Examples of the monomer represented by the general formula (3) include a monoester of an unsaturated monocarboxylic acid. Examples of the unsaturated monocarboxylate monoester include methyl (meth)acrylate, ethyl (meth)acrylate, 2-hydroxyethyl (meth)acrylate, 2-hydroxypropyl (meth)acrylate, 4-hydroxybutyl (meth)acrylate, and glyceryl (meth)acrylate. Among them, 2-hydroxyethyl (meth)acrylate and 2-hydroxypropyl (meth)acrylate are preferable.

When the copolymer (A) has the constituent unit (III), the copolymer may have only one constituent unit (III), or two or more constituent units (III) derived from different monomers.

When the copolymer (A) has at least two constituent units selected form the group consisting of the constituent units (I) to (III), it is possible to enhance the compatibility with the powdery cellulose so that the powdery cellulose can be dispersed into the cement composition more uniformly.

Besides the constituent units (I) to (III), the copolymer (A) may have the constituent unit (IV).

<Constituent Unit (IV)>

The constituent unit (IV) is the constituent unit derived from a monomer capable of copolymerizing with the monomers represented by the general formulae (1) to (3). The monomer capable of copolymerizing with the monomers represented by the general formulae (1) to (3) can be structurally distinguished from the monomers represented by the general formulae (1) to (3). The monomer constituting the constituent unit (IV) is not particularly limited, and examples thereof include the following monomers. These monomers may be used singly or as a combination of two or more of them.

The monomer represented by the general formula (IV-1);

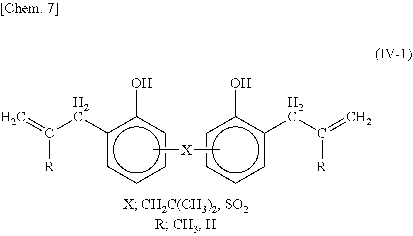

Examples of the monomer represented by the general formula (IV-1) include 3- and 3′-allyl substituted bisphenols such as 4,4′-dihydroxydiphenylpropane, 4,4′-dihydroxydiphenylmethane, and 4,4′-dihydroxydiphenyl sulfone.

The monomer represented by the general formula (IV-2);

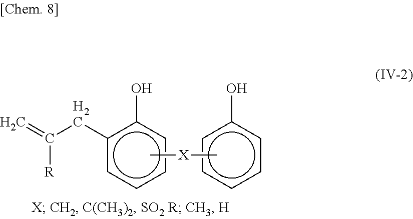

Examples of the monomer represented by the general formula (IV-2) include 3-allyl substituted bisphenols such as 4,4′-dihydroxydiphenylpropane, 4,4′-dihydroxydiphenylmethane, and 4,4′-dihydroxydiphenyl sulfone.

The monomer represented by the general formula (IV-3);

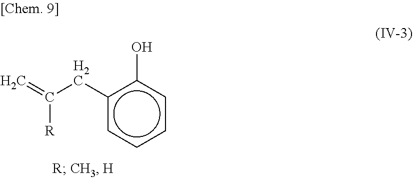

Example of the monomer represented by the general formula (IV-3) includes allyl phenol.

Half esters or diesters of an unsaturated dicarboxylic acid such as maleic acid, maleic anhydride, fumaric acid, itaconic acid, or citraconic acid with an alcohol having 1 to 30 carbon atoms;

Half amides or diamides of the above-mentioned unsaturated dicarboxylic acids with an amine having 1 to 30 carbon atoms;

Half esters, half amides, diesters, and diamides of the above-mentioned unsaturated dicarboxylic acid with a (poly)oxyalkylene alkyl ether or a (poly)oxyalkylene alkylamine obtained by adding 1 to 500 moles of an alkylene oxide having 2 to 18 carbon atoms to the above-mentioned alcohol or amine;

Half esters or diesters of the above-mentioned unsaturated dicarboxylic acids with a glycol having 2 to 18 carbon atoms or with a polyalkylene glycol having 2 to 500 addition mole numbers of these glycols;

Half amides of a maleamic acid with a glycol having 2 to 18 carbon atoms or with a polyalkylene glycol having 2 to 500 addition mole numbers of these glycols;

A (poly)ethylene glycol mono(meth)acrylate, a (poly)propylene glycol mono(meth)acrylate, a (poly)butylene glycol mono(meth)acrylate, and the like obtained by adding 1 to 500 moles of an alkylene oxide having 2 to 18 carbon atoms to an unsaturated monocarboxylic acid such as (meth)acrylic acid (except for the monomers represented by the general formulae (1) to (3));

(Poly)alkylene glycol di(meth)acrylates such as triethylene glycol di(meth)acrylate, (poly)ethylene glycol di(meth)acrylate, polypropylene glycol di(meth)acrylate, and (poly)ethylene glycol (poly)propylene glycol di(meth)acrylate;

Polyfunctional (meth)acrylates such as hexanediol di(meth)acrylate, trimethylolpropane tri(meth)acrylate, and trimethylolpropane di(meth)acrylate;

(Poly)alkylene glycol dimaleates such as triethylene glycol dimaleate and polyethylene glycol dimaleate;

Unsaturated sulfonates such as vinyl sulfonate, (meth)allyl sulfonate, 2-(meth)acryloxyethyl sulfonate, 3-(meth)acryloxypropyl sulfonate, 3-(meth)acryloxy-2-hydroxypropyl sulfonate, 3-(meth)acryloxy-2-hydroxypropyl sulfophenyl ether, 3-(meth)acryloxy-2-hydroxypropyloxy sulfobenzoate, 4-(meth)acryloxybutyl sulfonate, (meth)acrylamide methyl sulfonic acid, (meth)acrylamide ethyl sulfonic acid, 2-methylpopane sulfonate (meth)acrylamide, and styrene sulfonic acid, as well as a monovalent metal salt thereof, a divalent metal salt thereof, an ammonium salt thereof, and an organic amine salt thereof;

Amides such as methyl (meth)acrylamide of unsaturated monocarboxylic acids with an amine having 1 to 30 carbon atoms;

Vinyl aromatics such as styrene, α-methyl styrene, vinyl toluene, and p-methyl styrene;

Alkanediol mono(meth)acrylates such as 1,5-pentanediol mono(meth)acrylate and 1,6-hexanediol mono(meth)acrylate (except for the monomers represented by the general formula (3));

Dienes such as butadiene, isoprene, 2-mehyl-1,3-butadiene, and 2-chloro-1,3-butadiene;

Unsaturated amides such as (meth)acrylamide, (meth)acryl alkyl amide, N-methylol (meth)acrylamide, and N,N-dimethyl (meth)acrylamide;

Unsaturated cyanides such as (meth)acrylonitrile and α-chloroacrylonitrile;

Unsaturated esters such as vinyl acetate and vinyl propionate;

Unsaturated amines such as aminoethyl (meth)acrylate, methyl aminoethyl (meth)acrylate, dimethyl aminoethyl (meth)acrylate, dimethyl aminopropyl (meth)acrylate, dibutyl aminoethyl (meth)acrylate, and vinyl pyridine (except for the monomers represented by the general formula (3));

Divinyl aromatics such as divinyl benzene; and cyanurates such as triallyl cyanurate;

Allyls such as (meth)allyl alcohol and glycidyl (meth)allyl ether;

Vinyl ethers or allyl ethers such as methoxy polyethylene glycol monovinyl ether, polyethylene glycol monovinyl ether, methoxy polyethylene glycol mono(meth)allyl ether, and polyethylene glycol mono(meth)allyl ether (except for the monomers represented by the general formula (1));

Siloxane derivatives such as polydimethyl siloxane propylamino maleinamidic acid, polydimethyl siloxane aminopropylene amino maleinamidic acid, polydimethyl siloxane-bis-(propylaminomaleinamidic acid), polydimethyl siloxane-bis-(dipropyleneaminomaleinamidic acid), polydimethyl siloxane-(1-propyl-3-acrylate), polydimethyl siloxane-(1-propyl-3-methacrylate), polydimethyl siloxane-bis-(1-propyl-3-acrylate), and polydimethyl siloxane-bis-(1-propyl-3-methacrylate) (except for the monomers represented by the general formula (3)).

The copolymer (A) may have only one constituent unit (IV) or two or more constituent units (IV) derived from different monomers with each other.

In the copolymer (A), each constituent unit (I) to (IV) may be the constituent unit formed from one monomer, or the constituent unit formed from a combination of two or more monomers. Among them, the copolymer (A) is preferably the copolymer (A1) that is a combination of the constituent unit (I) and the constituent unit (II) or the copolymer (A2) that is a combination of the constituent units (I) to (III).

<Production Method of the Copolymer (A)>

The copolymer (A) may be produced by copolymerizing prescribed monomers according to heretofore known methods. Examples of the polymerization method include a polymerization method such as a polymerization in a solvent or a bulk polymerization.

Examples of the solvent used in the polymerization in a solvent include water; lower alcohols such as methyl alcohol, ethyl alcohol, and isopropyl alcohol; aromatic hydrocarbons such as benzene, toluene, and xylene; aliphatic hydrocarbons such as cyclohexane and n-hexane; esters such as ethyl acetate; and ketones such as acetone and methyl ethyl ketone. In view of solubilities of the raw material monomer as well as the copolymer to be obtained, it is preferably to use at least any one of water and the lower alcohol, and more preferably to use water.

When the polymerization reaction is carried out in a solvent, each monomer as well as a polymerization initiator may be added separately and continuously in drops into a reaction vessel, or a mixture of monomers and a polymerization initiator may be added separately and continuously in drops into a reaction vessel. Alternatively, a solvent is charged into a reaction vessel, and then a mixture of monomers with a solvent and a solution of a polymerization initiator may be added separately and continuously in drops into the reaction vessel, or part or all of the monomers are charged into a reaction vessel, and then a polymerization initiator may be continuously added in drops.

The polymerization initiator that can be used in the polymerization reaction is not particularly limited. Examples of the polymerization initiator that can be used at the time when the polymerization reaction is carried out in the water solvent include persulfates salt such as ammonium persulfate, sodium persulfate, and potassium persulfate; and water-soluble peroxides such as t-butyl hydroperoxide and hydrogen peroxide. At this time, a accelerator such as L-ascorbic acid, sodium bisulfite, or Mohr's salt may be used together. Examples of the polymerization initiator that can be used at the time when the polymerization reaction is carried out in an organic solvent such as a lower alcohol, an aromatic hydrocarbon, an aliphatic hydrocarbon, an ester, or a ketone include peroxides such as benzoyl peroxide and lauryl peroxide; hydroperoxides such as cumene peroxide; and azo compounds such as azobisisobutyronitrile. At this time, an accelerator such as an amine compound may be used together. The polymerization initiator that can be used when the polymerization reaction is carried out in a mixed solvent of water and a lower alcohol may be appropriately selected from the above-mentioned polymerization initiators or from a combination of the polymerization initiator and the accelerator. The polymerization temperature is different depending on the polymerization condition such as the solvent and the polymerization initiator to be used, but is usually 50 to 120° C.

In the polymerization reaction, a molecular weight may be controlled by using a chain-transfer agent as needed. Examples of the chain-transfer agent include heretofore known thiol compounds such as mercaptoethanol, thioglycerol, thioglycolic acid, 2-mercaptopropionic acid, 3-mercaptopropionic acid, thiomalic acid, octyl thioglycolate, and 2-mercaptoethane sulfonic acid; lower oxides or salts thereof such as phosphorous acid, hypophosphorous acid, or salts thereof (sodium hypophosphite, potassium hypophosphite, and the like), and sulfurous acid, hydrogen sulfite, dithionous acid, metabisulfite, or salts thereof (sodium sulfite, potassium sulfite, sodium hydrogen sulfite, potassium hydrogen sulfite, sodium dithionate, potassium dithionate, sodium metabisulfite, potassium metabisulfite, and the like). These chain-transfer agents may be used singly, or as a mixture of two or more of them.

When the polymerization reaction is carried out in the water solvent upon obtaining the copolymer (A), pH at the time of the polymerization reaction is usually strongly acidic due to the effect of the monomer having an unsaturated bond. However, pH may be adjusted to a suitable value. When pH needs to be adjusted at the time of the polymerization reaction, pH may be adjusted by using an acidic substance such as phosphoric acid, sulfuric acid, nitric acid, an alkylphosphoric acid, an alkyl sulfate, an alkylsulfonic acid, and an (alkyl)benzenesulfonic acid. Among these acidic substances, phosphoric acid is preferably used because of having a pH-buffering action. In this case, in order to avoid instability of the ester bond existed in the ester monomer, the polymerization reaction is preferably carried out in the pH range of 2 to 7. An alkali substance to be used for pH adjustment is not particularly limited, and alkali substances such as NaOH and Ca(OH)₂ are generally used. The pH adjustment may be carried out to the monomers before the polymerization reaction, or to the copolymer solution after the polymerization reaction. Alternatively, part of the alkali substance is added before the polymerization reaction, and after the polymerization, the pH adjustment may be further carried out to the copolymer (for example, pH is adjusted so as to be 3 to 7).

The lower limit of the solid concentration in the copolymer (A) is preferably 5% or more by weight, and more preferably 15% or more by weight. The upper limit thereof is preferably 70% or less by weight, and more preferably 65% or less by weight. Accordingly, when the copolymer (A) is used as the component (A), the solid concentration in the copolymer (A) is preferably 5 to 70% by weight, and more preferably 15 to 65% by weight, relative to total weight of the additive for the cement composition.

The copolymer (A) may also be in a liquid form. Example of the solvent in the case of the liquid form includes an aqueous solvent. Examples of the aqueous solvent include water, alcohols having 1 to 6 carbon atoms (ethyl alcohol, methyl alcohol, ethylene glycol, diethylene glycol, and the like), and ketones having 1 to 6 carbon atoms (methyl isobutyl ketone, acetone, and the like). These aqueous solvents may be used singly, or as a mixture of two or more of them. As the aqueous solvent, water is preferable.

The component (A) may include at least one monomer selected from the group consisting of the general formulae (1) to (3) being the raw materials of the copolymer (A). Upon obtaining the copolymer (A), the processes such as removal of the reaction solvent, concentration, and purification may be carried out as needed. These processes may be the heretofore known methods.

The lower limit of the weight average molecular weight (Mw) of the copolymer (A) is preferably 5,000 or more, and more preferably 6,000 or more. When the copolymer (A) having such a weight average molecular weight is used as the component (A), upon addition of the additive for the cement composition the cement composition can be well dispersed so that it is possible to obtain the water reducing rate higher than that of the AE water reducing agent such as a lignin sulfonate type or an oxycarboxylate type. Accordingly, flowability or workability can be improved. The upper limit of the weight average molecular weight is preferably 60,000 or less, and more preferably 50,000 or less. When the copolymer (A) having such a weight average molecular weight is used as the component (A), agglomeration of the particles in the cement composition can be suppressed so that the workability can be improved. Accordingly, the weight average molecular weight thereof is preferably 5,000 to 60,000, and more preferably 6,000 to 50,000.

The lower limit of the molecular weight distribution (Mw/Mn) of the copolymer (A) is preferably 1.0 or more, and more preferably 1.2 or more. The upper limit thereof is preferably 3.0 or less, and more preferably 2.5 or less. The molecular weight distribution is preferably in the range of 1.0 to 3.0, more preferably in the range of 1.2 to 3.0, and further preferably in the range of 1.2 to 2.5.

The weight average molecular weight may be measured by heretofore known method of conversion to polyethylene glycol using a gel permeation chromatography (GPC). The measurement condition of GPC is not particularly limited, and for example, the following condition may be employed. Note that the weight average molecular weights in Examples to be described later are the values obtained under this measurement condition.

Measurement apparatus: manufactured by Tosoh Corp.

Used columns: Shodex Column OH-pak SB-806HQ, SB-804HQ, and SB-802.5HQ

Eluent: 0.05 mM sodium nitrate/acetonitrile 8/2 (v/v)

Standard substance: polyethylene glycol (manufactured by Tosoh Corp. or GL Sciences Inc.)

Detector: differential refractometer (manufactured by Tosoh Corp.)

Calibration curve: polyethylene glycol standard

(1-3) Component (S) and Component (G)

It is preferable that the additive for a cement composition of the present invention further includes any one of the component (S) and the component (G).

(1-3-1) Component (S)

By including the component (S), the component (B) can be dispersed more uniformly into the cement composition. Examples of the component (S) include naphthalenesulfonate formaldehyde condensate, melaminesulfonate formaldehyde condensate, and lignin sulfonate salt. The component (S) may be used singly, or as a combination of two or more of the component. The content of the component (S) is preferably 0.01 to 50% by weight relative to the component (A) to be described below.

(1-3-2) Component (G)

By including the component (G), a hydration reaction of the cement composition can be delayed so that the time necessary for setting can be prolonged. Examples of the delaying agent include an oxycarboxylate such as gluconic acid, a gluconate salt, citric acid, and a citrate salt; a saccharide such as glucose; and a saccharide alcohol such as sorbitol. The component (G) may be used singly, or as a combination of two or more of the component. The content of the component (G) is preferably 0.01 to 50% by weight relative to the component (A) to be described below.

(1-4) Arbitrary Component

The additive for a cement composition of the present invention may include an arbitrary component other than the component (A), the component (B), the component (S), and the component (G) so far as the effects of the present invention are not impaired. Examples of the arbitrary component include heretofore known additives for a cement composition such as a water-soluble polymer, a curing accelerator, a thickener, a polymer emulsion, an air entraining agent, a cement wetting agent, an expanding agent, a water-proofing agent, a thickener, a flocculant, a drying shrinkage reducing agent, a strength enhancer, an anti-foaming agent, an AE agent, and a surfactant. These may be used singly, or as a mixture of two or more of these.

As the water-soluble polymer, polyalkylene glycol may be mentioned. More specific examples thereof include polyethylene glycol, polypropylene glycol, polyethylene polypropylene glycol, and polyethylene polybutylene glycol. The content amount of the water-soluble polymer is preferably 0.01 to 50% by weight relative to the component (A).

Examples of the curing accelerator include soluble calcium salts such as calcium chloride, calcium nitrite, and calcium nitrate; chlorides such as iron chloride and magnesium chloride; thiosulfate salts; formic acid; and formate salts such as calcium formate. The curing accelerator may be used singly, or as a mixture of two or more of these accelerators. The content amount of the curing accelerator is preferably 0.01 to 50% by weight relative to the component (A).

(1-5) Use Embodiment of the Additive for the Cement Composition

The additive for a cement composition of the present invention may be used in the form of an aqueous solution or in the dried powder form. Alternatively, the additive for a cement composition of the present invention in the powdered form is pre-mixed with the components such as cement powders and dry mortar, which constitute the cement composition other than water, and then, the resultant may be used as the pre-mixed product, which is used by adding water at the time of plastering, floor finishing, grouting, or the like.

(2) Cement Composition

The cement composition of the present invention includes the additive for the cement composition described in the above (1). More specifically, the cement composition of the present invention is a cement paste, a mortar, a concrete, a plaster, and the like, each of which is prepared by adding the additive for the cement composition to a hydraulic material such as cement.

Examples of the hydraulic material include cement, gypsum (hemihydrate gypsum, gypsum dihydrate, and the like), and dolomite. The most general hydraulic material is cement.

The cement is not particularly limited. Examples thereof include Portland cements (ordinary, high early strength, ultrahigh early strength, moderate heat, sulphate resistance, and a low-alkali type of each), various mixed cement (a blast furnace cement, a silica cement, and a fly ash cement), a white Portland cement, an alumina cement, a super hardening cement (a 1-clinker fast hardening cement, a 2-clinker fast hardening cement, and a magnesium phosphate cement), a cement grout, an oil well cement, a low heat cement (a low heat blast furnace cement, a fly ash admixture blast furnace cement of a low heat type, and a belite high content cement), a ultra-high strength cement, a cement-type solidifying agent, and an eco-cement (cement produced from any one or more of a municipal waste incineration ash and a sewage sludge incineration ash as the raw material). The cement may be added with a blast furnace slug, a fly ash, a cinder ash, a clinker ash, a husk ash, a silica fume, a silica powder, particulates such as limestone powder, gypsum, or the like.

The cement may also include an aggregate. The aggregate may be any of a fine aggregate and a coarse aggregate. Examples thereof include refractory aggregates such as a sand, a gravel, a crushed stone, a water granulated slug, a regenerated aggregate and the like, a siliceous aggregate, a silica powder (silica powder), a clay matter, a zircon matter, a high alumina matter, a silicon carbide matter, a graphite matter, a chrome matter, a chrome magnesia matter, and a magnesia matter.

In the cement composition, the addition amount of the additive for the cement composition is not particularly limited. For example, in the case where the cement composition is a mortar or a concrete, when the addition amount described below is used, it is possible to prepare the cement composition having a superior flowability because the powdery cellulose can be uniformly dispersed into a cement matrix and an increase in viscosity of the fresh concrete can be suppressed. Here, the addition amount is the ratio to a total weight of the hydraulic material (cement).

The lower limit of the addition amount (blending amount) of the component (A) is preferably 0.01% or more by weight, more preferably 0.02% or more by weight, and further preferably 0.05% by weight. The upper limit thereof is preferably 5.0% or less by weight, more preferably 2.0% or less by weight, and further preferably 1.0% or less by weight. That is, the addition amount thereof is preferably 0.01 to 5.0% by weight, more preferably 0.02 to 2.0% by weight, and further preferably 0.05 to 1.0% by weight.

The lower limit of the addition amount (blending amount) of the component (B) is preferably 1% or more by weight, and more preferably 5% or more by weight. The upper limit thereof is preferably 50° or less by weight, and more preferably 40° or less by weight. That is, the addition amount thereof is preferably 1 to 50% by weight, more preferably 5 to 50% by weight, and further preferably 5 to 40% by weight.

The cement composition described above is useful, for example, as concrete such as a ready-mixed concrete, a concrete for a concrete secondary product (precast concrete), a centrifugal molding concrete, a vibration compacting concrete, a steam curing concrete, an autoclaved lightweight concrete, an autoclaved lightweight aerated concrete, and a shotcrete. In addition, the cement composition is also useful as a mortar or a concrete that is required to have a high flowability such as a moderate fluid concrete (concrete having the slump value of 22 to 25 cm), a high fluid concrete (concrete having the slump value of 25 cm or more as well as the slump flow value of 50 to 70 cm), a self-filling concrete, and a self-leveling material.

(3) Residential Exterior Wall Material

The residential exterior wall material of the present invention uses the cement composition described in the above (2). Therefore, it has not only the essential characteristics as the construction material such as a less shrinkage strain and a large reinforcing effect but also has the aesthetic characteristics such as a fine as well as homogeneous texture. Accordingly, it has suitable characteristics to be used as the residential exterior wall material.

### EXAMPLES

Hereinafter, one embodiment of the present invention will be specifically explained by referring to Examples. Note that the present invention is not limited to the embodiment described in Examples. Also note that in Examples, “%” means “% by weight”, and that “part” means “part by weight”, unless otherwise specifically described. The various physical values are the values measured with the methods that are described in the preceding paragraphs of this specification.

### Production Example A1-1

Into a stainless-steel-made reaction vessel equipped with a thermometer, a stirrer, a reflux condenser, a nitrogen introduction tube, and liquid-dropping equipment, 5,010 kg of water and 5,000 kg of the ethylene oxide adduct of 3-methyl-3-butene-1-ol (30 of average addition mole numbers of the ethylene oxide) (3MBO) (24 mol %) were charged, and then the inlet gas of the reaction vessel was replaced with nitrogen while stirring. After the temperature thereof was raised to 80° C. under a nitrogen atmosphere, an aqueous monomer solution obtained by mixing 800 kg of acrylic acid (AA) (76 mol %) with 5,010 kg of water, and a stirred mixture of 120 kg of ammonium persulfate as well as 1,880 kg of water were separately and continuously added in drops, each over a period of 2 hours, into the reaction vessel whose temperature was kept at 80° C. After the polymerization reaction was carried out for 1 hour with keeping the temperature at 100° C., the reaction mixture was cooled to 80° C. in the additional equipment disposed after the reaction vessel, and then the resultant was neutralized to pH 6 by sodium hydroxide with simultaneous addition of water to obtain an aqueous solution of the copolymer (weight average molecular weight Mw of 20,200, Mw/Mn of 1.7) with 30% concentration (A1-1).

### Production Example A1-2

Into a stainless-steel-made reaction vessel equipped with a thermometer, a stirrer, a reflux condenser, a nitrogen introduction tube, and liquid-dropping equipment, 5,010 kg of water, 5,000 kg of the ethylene oxide adduct of 3-methyl-3-butene-1-ol (120 of average addition mole numbers of ethylene oxide) (3MBO) (13 mol %), and 100 kg of maleic acid (MA) (12 mol %) were charged, and then the inlet gas of the reaction vessel was replaced with nitrogen while stirring. After the temperature thereof was raised to 80° C. under a nitrogen atmosphere, an aqueous monomer solution obtained by mixing 400 kg of acrylic acid (AA) (75 mol %) with 5,010 kg of water as well as 36 kg of 3-mercaptopropionic acid, and a stirred mixture of 120 kg of ammonium persulfate as well as 1,880 kg of water were separately and continuously added in drops, each over a period of 2 hours, into the reaction vessel whose temperature was kept at 80° C. After the polymerization reaction was carried out for 1 hour with keeping the temperature at 100° C., the reaction mixture was cooled to 80° C. in the additional equipment disposed after the reaction vessel, and then the resultant was neutralized to pH 6 by sodium hydroxide with simultaneous addition of water to obtain an aqueous solution of the copolymer (weight average molecular weight Mw of 19,100, Mw/Mn of 1.7) with 30% concentration (A1-2).

### Production Example A1-3

Into a stainless-steel-made reaction vessel equipped with a thermometer, a stirrer, a reflux condenser, a nitrogen introduction tube, and liquid-dropping equipment, 8,000 kg of water was charged, and then the inlet gas of the reaction vessel was replaced with nitrogen while stirring. After the temperature thereof was raised to 75° C. under a nitrogen atmosphere, an aqueous monomer solution obtained by mixing 4,000 kg of methoxy polyethylene glycol methacrylate (MPEG-MA) (18 of average addition mole numbers of ethylene oxide) (24 mol %), 1,200 kg of methacrylic acid (MAA) (76 mol %), 1,470 kg of water, as well as 56 kg of 3-mercaptopropionic acid, and a stirred mixture of 70 kg of sodium persulfate as well as 2,030 kg of water were separately and continuously added in drops, each over a period of 2 hours, into the reaction vessel whose temperature was kept at 75° C. After the polymerization reaction was carried out for 1 hour with keeping the temperature at 75° C., the reaction mixture was cooled to 65° C. in the additional equipment disposed after the reaction vessel, and then the resultant was neutralized to pH 6 by sodium hydroxide with simultaneous addition of water to obtain an aqueous solution of the copolymer (weight average molecular weight Mw of 17,000, Mw/Mn of 1.6) with 30% concentration (A1-3).

### Production Example A1-4

Into a stainless-steel-made reaction vessel equipped with a thermometer, a stirrer, a reflux condenser, a nitrogen introduction tube, and liquid-dropping equipment, 9,500 kg of water was charged, and then the inlet gas of the reaction vessel was replaced with nitrogen while stirring. After the temperature thereof was raised to 75° C. under a nitrogen atmosphere, an aqueous monomer solution obtained by mixing 2,800 kg of methoxy polyethylene glycol methacrylate (MPEG-MA) (150 of average addition mole numbers of ethylene oxide) (9 mol %), 350 kg of methacrylic acid (MAA) (91 mol %), 1,470 kg of water, as well as 56 kg of 3-mercaptopropionic acid, and a stirred mixture of 70 kg of sodium persulfate as well as 2,030 kg of water were separately and continuously added in drops, each over a period of 2 hours, into the reaction vessel whose temperature was kept at 75° C. After the polymerization reaction was carried out for 1 hour with keeping the temperature at 75° C., the reaction mixture was cooled to 65° C. in the additional equipment disposed after the reaction vessel, and then the resultant was neutralized to pH 6 by sodium hydroxide with simultaneous addition of water to obtain an aqueous solution of the copolymer (weight average molecular weight Mw of 26,000, Mw/Mn of 1.9) with 20% concentration (A1-4).

### Production Example A2-1

Into a stainless-steel-made reaction vessel equipped with a thermometer, a stirrer, a reflux condenser, a nitrogen introduction tube, and liquid-dropping equipment, 4,440 kg of water and 2,820 kg of polyethylene glycol polypropylene glycol monoallyl ether (37 of average addition mole numbers of ethylene oxide and 3 of average addition mole numbers of propylene oxide, and random adduct of ethylene oxide and propylene oxide) (PEG-AL) (5 mol %) were charged, and then the inlet gas of the reaction vessel was replaced with nitrogen while stirring. After the temperature thereof was raised to 80° C. under a nitrogen atmosphere, an aqueous monomer solution obtained by mixing 1,050 kg of methacrylic acid (MA) (41 mol %), 150 kg of acrylic acid (AA) (7 mol %), 1,890 kg of methoxy polyethylene glycol methacrylate (150 of average addition mole numbers of ethylene oxide) (MPEG-MA) (1 mol %), 1,800 kg of 2-hydroxypropyl acrylate (HPA) (46 mol %), 240 kg of 3-mercaptopropionic acid, as well as 4,950 kg of water, and a stirred mixture of 90 kg of ammonium persulfate as well as 1,410 kg of water were separately and continuously added in drops, each over a period of 2 hours, into the reaction vessel whose temperature was kept at 80° C. After the polymerization reaction was carried out for 1 hour with keeping the temperature at 100° C., the reaction mixture was cooled to 80° C. in the additional equipment disposed after the reaction vessel, and then the resultant was neutralized to pH 4 by sodium hydroxide with simultaneous addition of water to obtain an aqueous solution of the copolymer (weight average molecular weight Mw of 11,100, Mw/Mn of 1.5) with 40% concentration (A2-1).

The kinds as well as blending amounts of the monomers used in Production Examples (A1-1) to (A1-4) and (A2-1), the concentration during polymerization reaction, the concentration of the aqueous solution at the termination of the reaction, and the pH value of the aqueous solution at the termination of the reaction are shown in Table 1.

TABLE 1

| | | | | | | | | During | | |
|---|---|---|---|---|---|---|---|---|---|---|
| | | | | | | | | polymerization | | |
| Production | Parts by weight | | | | | | | reaction | Aqueous solution | |
| Example | 3MBO | PEG-AL | MPEG-MA | AA | MAA | MA | HPA | Concentration | Concentration | pH |
| A1-1 | 5,000 | — | — | 800 | — | — | — | 33% | 30% | 6 |
| A1-2 | 5,000 | — | — | 400 | — | 100 | — | 32% | 30% | 6 |
| A1-3 | — | — | 4,000 | — | 1,200 | — | — | 31% | 30% | 6 |
| A1-4 | — | — | 2,800 | — | 350 | — | — | 20% | 20% | 6 |
| A2-1 | — | 2,820 | 1,890 | 150 | 1,050 | — | 1,800 | 42% | 40% | 4 |

Here, details of the monomers in Table 1 are shown as follows:

3MBO: ethylene oxide adduct of 3-methyl-3-butene-1-ol

PEG-AL: polyethylene glycol polypropylene glycol monoallyl ether

MPEG-MA: methoxy polyethylene glycol methacrylate

AA: acrylic acid

MAA: methacrylic acid

MA: maleic acid

HPA: 2-hydroxypropyl acrylate

The materials used as the component (B) (powdery cellulose) are shown as follows.

Component (B-1): the bleached wooden pulp sheet (pulp derived from hardwood LBKP having 4,000 of the average degree of polymerization, manufactured by Nippon Paper Industries, Co., Ltd.) used as the raw material was subjected to an acidic hydrolysis treatment by hydrochloric acid. After neutralization, the resultant was mechanically crushed by using a tornado mill (manufactured by Nikkiso Co., Ltd.). The powdery cellulose thus obtained had the average particle diameter of 35.1 μm, the apparent specific weight of 0.30 g/cm³, the average degree of polymerization of 680, the alkali elution rate of 9.8%, and the angle of repose of 58.1°.

Component (B-2): the bleached wooden pulp sheet (pulp derived from hardwood LBKP having 4,000 of the average degree of polymerization, manufactured by Nippon Paper Industries, Co., Ltd.) used as the raw material was subjected to an acidic hydrolysis treatment by hydrochloric acid. After neutralization, the resultant was mechanically crushed by using a tornado mill (manufactured by Nikkiso Co., Ltd.). The powdery cellulose thus obtained had the average particle diameter of 25.8 μm, the apparent specific weight of 0.53 g/cm³, the average degree of polymerization of 420, the alkali elution rate of 11.3%, and the angle of repose of 46.8°.

Component (B-3): the bleached wooden pulp sheet (pulp derived from hardwood LDPT having 1,550 of the average degree of polymerization, manufactured by Nippon Paper Industries, Co., Ltd.) used as the raw material was mechanically crushed by using a tornado mill (manufactured by Nikkiso Co., Ltd.). The powdery cellulose thus obtained had the average particle diameter of 39.3 μm, the apparent specific weight of 0.31 g/cm³, the average degree of polymerization of 1,380, the alkali elution rate of 1.9%, and the angle of repose of 59.4°.

Component (B-4): the bleached wooden pulp sheet (pulp derived from softwood NDSP having 1,600 of the average degree of polymerization, manufactured by Nippon Paper Industries, Co., Ltd.) used as the raw material was mechanically crushed by using a tornado mill (manufactured by Nikkiso Co., Ltd.). The powdery cellulose thus obtained had the average particle diameter of 72.3 μm, the average degree of polymerization of 1,480, the apparent specific weight of 0.25 g/cm³, the alkali elution rate of 1.7%, and the angle of repose of 58.2°.

Component (B-5): the bleached wooden pulp sheet (pulp derived from softwood NDSP having 1,600 of the average degree of polymerization, manufactured by Nippon Paper Industries, Co., Ltd.).

CNF (cellulose nanofiber): 5 g of the bleached unbeaten softwood pulp (manufactured by Nippon Paper Industries, Co., Ltd.) (absolutely dried) was added to 500 mL of an aqueous solution in which 78 mg (0.5 mmol) of TEMPO (manufactured by Sigma-Aldrich Corp.) and 754 mg of sodium bromide (7.4 mmol) were dissolved, and then the resulting mixture was stirred until the pulp was uniformly dispersed. After 16 mL of an aqueous 2-M sodium hypochlorite solution was added to the reaction system, the pH value thereof was adjusted to 10.3 by an aqueous 0.5N hydrochloric acid solution to start the oxidation reaction (oxidation process). Because the pH value in the system was decreased with the progress of the reaction, an aqueous 0.5N sodium hydroxide solution was added as appropriate so as to adjust the pH value at 10. After 2 hours of the reaction, the reaction mixture was filtrated with a glass filter, and then sufficiently washed with water to obtain the oxidized cellulose having the carboxylate amount of 1.60 mmol/g.

Next, to the 5% (w/v) oxidized cellulose slurry, 1% (w/v) of the hydrogen peroxide was added relative to the oxidized cellulose, and then the pH value of the resulting mixture was adjusted to 12 by an aqueous 1M sodium hydroxide solution. After this slurry was treated at 80° C. for 2 hours, the resultant was filtrated through a glass filter, and sufficiently washed with water (viscosity-lowering process: alkali hydrolysis).

The 2% (w/v) oxidized cellulose slurry subjected to the viscosity-lowering process was treated with a ultra-high pressure homogenizer (20° C., 140 MPa) for five times to obtain the anion-modified cellulose nanofiber dispersion solution in the form of a transparent gel (1% (w/v) of the cellulose nanofiber dispersion solution (B-type viscosity (60 rpm, 20° C.): 356 mPa·s)). In the anion-modified cellulose nanofiber thus obtained, the average fiber length was 6 nm, and the aspect ratio was 100 or more.

<Mortar Test>

The cement, water, as well as silica powder blended as described in Table 2, and the additives for the cement composition described in Tables 3 and 4 were added into a mortar mixer under an environmental temperature (20° C.), and then they were mechanically kneaded at a low speed for 60 seconds and at a high speed for 90 seconds (the component (A) was added as a mixture with water) to obtain the mortar (cement composition) of each of Examples and Comparative Examples. By using the mortar thus obtained, the measurement of the mortar flow value, the measurement of the J14 funnel flow-down time, the uniform dispersibility of cellulose, and the shrinkage strain test were carried out as described below. The test results thereof are shown in Tables and 5 and 6.

TABLE 2

| W/C | W | C | S | CP |
|---|---|---|---|---|
| 300% | 540 g | 180 g | 1191 g | 45 g |

Here, details of the symbols in Table 2 are shown as follows:

C: mixture of equal amounts of the following 3 cements.

Ordinary Portland cement (specific weight of 3.16, manufactured by Ube-Mitsubishi Cement Corp.)

Ordinary Portland cement (specific weight of 3.16, manufactured by Taiheiyo Cement Corp.)

Ordinary Portland cement (specific weight of 3.16, manufactured by Tokuyama Corp.)

W: tapped water

S: silica powder #250 (specific weight of 2.63, manufactured by Marutou Co., Ltd.)

CP: powdery cellulose

TABLE 3

| | Component (A) | | | | | Component (S) | Component (G) |
|---|---|---|---|---|---|---|---|
| | | | | Addition | Component (B) | Addition | Addition amount |
| | A1 | A2 | Mass ratio | amount (%) | kinds | amount (%) | (%) |
| Ex. 1 | A1-1 | — | — | 0.90 | B-1 | — | — |
| Ex. 2 | A1-1 | — | — | 0.90 | B-2 | — | — |
| Ex. 3 | A1-1 | — | — | 0.60 | B-3 | — | — |
| Ex. 4 | A1-1 | — | — | 0.60 | B-4 | — | — |
| Ex. 5 | A1-2 | — | — | 0.60 | B-4 | — | — |
| Ex. 6 | A1-3 | — | — | 0.60 | B-4 | — | — |
| Ex. 7 | A1-4 | — | — | 0.60 | B-4 | — | — |
| Ex. 8 | — | A2-1 | — | 0.60 | B-4 | — | — |
| Ex. 9 | A1-2/A1-4 | — | 75/25 | 0.60 | B-1 | — | — |
| Ex. 10 | A1-2/A1-4 | — | 25/75 | 0.60 | B-1 | — | — |
| Ex. 11 | A1-2/A1-4 | — | 50/50 | 0.60 | B-1 | 0.05 | — |
| Ex. 12 | A1-2/A1-4 | — | 50/50 | 0.60 | B-1 | — | 0.05 |
| Ex. 13 | A1-2/A1-4 | — | 50/50 | 0.60 | B-1 | 0.05 | 0.05 |
| Comp. | A1-1 | — | — | 0.90 | B-5 | — | — |
| Ex. 1 | | | | | | | |

| | | | | | | |
|---|---|---|---|---|---|---|
| Comp. | A1-1 | 0.90 | CNF- | — | — | — |
| Ex. 2 | | | | | | |

TABLE 4

| | | | | | | Component | Component |
|---|---|---|---|---|---|---|---|
| | | | Component (B) | | | (S) | (G) |
| | Component (A) | | | | B1/B2 | Addition | Addition |
| | | Addition amount (%) | B1 | B2 | weight ratio | amount (%) | amount (%) |
| Ex. 14 | A1-1 | 0.60 | B-1 | B-3 | 25/75 | — | — |
| Ex. 15 | A1-1 | 0.60 | B-1 | B-4 | 25/75 | — | — |
| Ex. 16 | A1-1 | 0.60 | B-2 | B-3 | 25/75 | — | — |
| Ex. 17 | A1-1 | 0.60 | B-2 | B-4 | 25/75 | — | — |
| Ex. 18 | A1-1 | 0.60 | B-1 | B-3 | 1/99 | — | — |
| Ex. 19 | A1-1 | 0.60 | B-1 | B-3 | 40/60 | — | — |
| Ex. 20 | A1-2 | 0.60 | B-1 | B-3 | 25/75 | — | — |
| Ex. 21 | A1-3 | 0.60 | B-1 | B-3 | 25/75 | — | — |
| Ex. 22 | A1-4 | 0.60 | B-1 | B-3 | 25/75 | — | — |
| Ex. 23 | A2-1 | 0.60 | B-1 | B-3 | 25/75 | — | — |
| Ex. 24 | A1-1 | 0.60 | B-1 | B-3 | 25/75 | 0.05 | — |
| Ex. 25 | A1-1 | 0.60 | B-1 | B-3 | 25/75 | — | 0.05 |
| Ex. 26 | A1-1 | 0.60 | B-1 | B-3 | 25/75 | 0.05 | 0.05 |

| | | | | | | |
|---|---|---|---|---|---|---|
| Comp. | A1-1 | 0.60 | B-5 | — | — | — |
| Ex. 3 | | | | | | |

Note that the addition amounts of the component (A), the component (S), and the component (G) in Tables 3 and 4 are the addition rates of the solid components relative to the cement weight. Details of the component (S) and the component (G) are described below.

Component (S): the lignin sulfonate type cement dispersant (trade name of Sun Flow RH, manufactured by Nippon Paper Industries, Co., Ltd.)

Component (G): the sodium gluconate type cement dispersant (trade name of C-PARN, manufactured by Fuso Chemical Co., Ltd.)

<Measurement of the Mortar Flow Value>

The mortar mentioned above was filled in a mini-slump corn being a hollow cylinder with the bottom plane diameter of 20 cm, the upper plane diameter of 10 cm, and the height of 30 cm. When the mini-slump corn was vertically pulled up, the average value of the diameters in two directions of the spread mortar on the table was taken as the mortar flow value.

<Evaluated standard of Viscosity: Measurement of the J14 Funnel Flow-Down Time>

The mortar was filled to the edge of the J14 funnel being the cylindrical shape with the upper edge of 70 mm, the lower edge of 14 mm, and the height of 392 mm, and the time until the mortar flowed down through the J14 funnel was measured. The shorter the flow-down time through the J14 funnel is, the lower the viscosity of the mortar is evaluated.

<Uniform Dispersivity of the Cellulose: Dispersivity Evaluation of the Fiber by Visual Observation>

A: there is no agglomerate of cellulose in the mortar thereby having smooth surface.

B: agglomerate of cellulose are partially observed in the mortar.

C: there are agglomerate.

The above evaluation results correspond to the cement composition having a fine as well as homogeneous texture.

<Shrinkage Strain>

The mortar was poured into the frame (10×10×40 cm, made of steel) of which an embedded-type gauge (manufactured by Tokyo Measuring Instruments Laboratory Co., Ltd.) was disposed (as the inner wall of the frame, a styrene board and a polytetrafluoroethylene sheet were disposed) in the central portion, and after 30 days of curing, the strain by self-shrinkage was evaluated. Here, the evaluation was carried out in such a way that after curing, water droplets were dropped with a syringe on the contact surface between the frame's inner wall and the mortar, and at the time when 30 seconds were passed after dropping, the visual evaluation was carried out with regard to whether the shrinkage strain took place or not.

A: almost all of the water remains on the mortar so that there is hardly a space formed by the shrinkage strain.

B: water remains on the mortar so that there is not so much of the space formed by the shrinkage strain.

C: water amount on the mortar is somewhat decreased so that there is the space formed by the shrinkage strain.

D: water amount on the mortar is decreased so that the space formed by the shrinkage strain is clearly observed.

TABLE 5

| | | | Evaluation of | |
|---|---|---|---|---|
| | | J14 Funnnel | uniform | Evaluation |
| | Mortar flow | flow-down time | dispersity | of shrinkage |
| | (mm) | (s) | of cellulose | strain |
| Ex. 1 | 320 | 30 | A | B |
| Ex. 2 | 313 | 28 | A | B |
| Ex. 3 | 325 | 40 | A | B |
| Ex. 4 | 313 | 39 | A | B |
| Ex. 5 | 308 | 38 | A | B |
| Ex. 6 | 322 | 39 | A | B |
| Ex. 7 | 312 | 40 | A | B |
| Ex. 8 | 319 | 41 | A | B |
| Ex. 9 | 312 | 35 | A | B |
| Ex. 10 | 311 | 36 | A | B |
| Ex. 11 | 321 | 34 | A | B |
| Ex. 12 | 315 | 39 | A | B |
| Ex. 13 | 316 | 34 | A | B |
| Comp. | 200 | Unmeasurable | C | C |
| Ex. 1 | | | | |
| Comp. | 320 | 80 | A | C |
| Ex. 2 | | | | |

TABLE 6

| | | | Evaluation | |
|---|---|---|---|---|
| | | J14 Funnnel | of uniform | Evaluation |
| | Mortar flow | flow-down time | dispersity | of shrinkage |
| | (mm) | (s) | of cellulose | strain |
| Ex. 14 | 320 | 30 | A | A |
| Ex. 15 | 313 | 28 | A | A |
| Ex. 16 | 325 | 31 | A | A |
| Ex. 17 | 313 | 28 | A | A |
| Ex. 18 | 308 | 38 | A | A |
| Ex. 19 | 322 | 39 | A | A |
| Ex. 20 | 312 | 28 | A | A |
| Ex. 21 | 319 | 28 | A | A |
| Ex. 22 | 311 | 29 | A | A |
| Ex. 23 | 321 | 31 | A | A |
| Ex. 24 | 311 | 30 | A | A |
| Ex. 25 | 320 | 29 | A | A |
| Ex. 26 | 310 | 28 | A | A |
| Comp. | 200 | Unmeasurable | C | C |
| Ex. 3 | | | | |

As can be seen in the results of Table 5, when the cellulose in the fiber form, not in the powdery form, was used (see Comparative Example 2), the mortar flow value was so large that the flowability of the mortar was good, but the J14 funnel flow-down time was long and the shrinkage strain was generated. It is presumed that the cellulose in the fiber form readily eluted from the terminal portion of the fiber so that the reinforcing effect could not be obtained and the shrinkage strain was poor. In addition, it is presumed that entanglement with other components were so large that the viscosity was increased. On the other hand, when the powdery cellulose was used (see Examples 1 to 13), the cement composition having a high mortar flow value and a short J14 funnel flow-down time could be prepared. In addition, the cellulose was uniformly dispersed so that the evaluation of the shrinkage strain was good. It is presumed that because of the powdery form the terminal portion of easily eluting was not so much that the reinforcing effect and the shrinkage strain were good. In addition, it is presumed that the entanglement with other components was not so much that the increase in viscosity was suppressed and the J14 funnel flow-down time was shortened.

When the raw material pulp sheet not having been made to the powdery form was used (see Comparative Example 1), the mortar flow value was low, the J14 funnel flow-down time could not be measured, the dispersivity was poor, and the shrinkage strain was generated. It is presumed that this occurred because the raw material pulp sheet itself did not disperse uniformly.

When the powdery cellulose whose average degree of polymerization is low was used (see Examples 1 and 2), the J14 funnel flow-down time was so short that the viscosity was low. This is because in the case of the cellulose whose average degree of polymerization is low was used, it is presumed that the increase in the viscosity due to the addition of the powdery cellulose can be suppressed. On the other hand, even in the case when the powdery cellulose whose average degree of polymerization is large was used (see Examples 3 to 8), almost the same results were obtained regardless of the different components (A) so that it can be seen that the desirable action effects of the present invention can be obtained.

When two different components (A) were used together (see Examples 9 and 10), almost the same results were obtained so that it can be seen that the desirable action effects of the present invention can be obtained. In addition, even in the case when the dispersant (component (S)) or the delaying agent (component (G)) was used (see Examples 11 to 13), almost the same results were obtained so that it can be seen that the desirable action effects of the present invention can be obtained.

As can be seen in the results of Table 6, when the component (B1) and the component (B2), both being the powdery celluloses, were used together (see Examples 14 to 26), the cement composition being high in the mortar flow value and short in the J14 funnel flow-down time could be prepared. In addition, the cellulose was uniformly dispersed and evaluation of the shrinkage strain was good. It is presumed that because of the powdery form the terminal portion of easily eluting was not so much that the reinforcing effect and the shrinkage strain could be improved. It is also presumed that because the entanglement with other components was not so much that the increase in viscosity was suppressed and the J14 funnel flow-down time was shortened.

When the raw material pulp sheet not having been made to the powdery form was used (see Comparative Example 3), the mortar flow value was low, the J14 funnel flow-down time could not be measured, the dispersivity was poor, and the shrinkage strain was generated. It is presumed that this occurred because the raw material pulp sheet itself was not uniformly dispersed.

Even when the component (B1) and the component (B2) were changed (see Examples 14 to 17), the J14 funnel flow-down time was short, the viscosity was low, the shrinkage strain hardly took place, and the reinforcing effect was good. When the cellulose having a low average degree of polymerization and the cellulose having a high average degree of polymerization are used together, it can be seen that the action effects of the present invention can be obtained regardless of the kind thereof. When the weight ratio of the component (B1) and the component (B2) was changed (see Examples 18 and 19), the J14 funnel flow-down time was slightly increased. Even when the component (A) was changed (see Examples 20 to 23), it can be seen that almost the same results are obtained and that the desired action effects of the present invention can be obtained.

In addition, even when the dispersant (component (S)) or the delaying agent (component (G)) was used (see Examples 24 to 25), it can be seen that almost the same results were obtained and that the desired action effects of the present invention could be obtained.

1. An additive for a cement composition, the additive comprising powdery cellulose.

2. The additive for a cement composition according to claim 1, wherein an average degree of polymerization of the powdery cellulose is 300 to 3,000.

3. The additive for a cement composition according to claim 1, wherein an alkali elution rate of the powdery cellulose is 0.1 to 12.0%.

4. The additive for a cement composition according to claim 1, comprising:
a copolymer; and
the powdery cellulose,
wherein:
the copolymer comprises at least two constituent units selected from the group consisting of a constituent unit (I) derived from a monomer represented by a following general formula (1), a constituent unit (II) derived from a monomer represented by a following general formula (2), and a constituent unit (III) derived from a monomer represented by a following general formula (3): 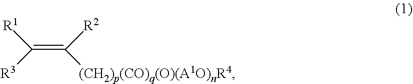
in the general formula (1),
R¹ to R³ each independently represents a hydrogen atom or an alkyl group having 1 to 3 carbon atoms,
p represents an integer of 0 to 2,
q represents 0 or 1,
A¹O represents identical or different oxyalkylene groups having 2 to 18 carbon atoms,
n represents an integer of 1 to 300, and
R⁴ represents a hydrogen atom or a hydrocarbon group having 1 to 30 carbon atoms; 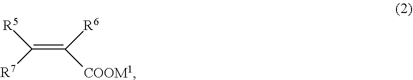
in the general formula (2),
R⁵ to R⁷ each independently represents a hydrogen atom, —CH₃, or —(CH₂)ᵣCOOM², where (CH₂)ᵣCOOM² may form an anhydride together with —COOM¹ or with another —(CH₂)ᵣCOOM², and when the anhydride is formed, there is no M¹ or M² present in these groups,
M¹ and M² each represents identical or different a hydrogen atom, an alkali metal, an alkali earth metal, an ammonium group, an alkyl ammonium group, or a substituted alkyl ammonium group, and
r represents an integer of 0 to 2; and 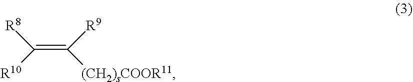
in the general formula (3),
R⁸ to R¹⁰ each independently represents a hydrogen atom or an alkyl group having 1 to 3 carbon atoms,
R¹¹ represents a hydrocarbon group having 1 to 4 carbon atoms as well as optionally including a heteroatom, and
s represents an integer of 0 to 2.

5. The additive for a cement composition according to claim 4, wherein the copolymer is at least any one of a copolymer (A1) having the constituent unit (I) and the constituent unit (II), and a copolymer (A2) having the constituent unit (I), the constituent unit (II), and the constituent unit (III).

6. A cement composition, comprising the additive of claim 4 and a cement, wherein an addition rate of the copolymer relative to a total weight of the cement is 0.01 to 5.0% by weight, and an addition rate of the powdery cellulose relative to the total weight of the cement is 1 to 50% by weight.

7. The additive for a cement composition according to claim 1, wherein the powdery cellulose comprises powdery cellulose (B1) having an average degree of polymerization of 300 to less than 900 as well as an alkali elution rate of 5.0 to 12.0%.

8. The additive for a cement composition according to claim 1, wherein the powdery cellulose comprises powdery cellulose (B2) having an average degree of polymerization of 900 to 3,000 as well as an alkali elution rate of 0.1 to less than 5.0%.

9. The additive for a cement composition according to claim 1, wherein the powdery cellulose comprises powdery cellulose (B1) having an average degree of polymerization of 300 to less than 900 as well as an alkali elution rate of 5.0 to 12.0% and powdery cellulose (B2) having an average degree of polymerization of 900 to 3,000 as well as an alkali elution rate of 0.1 to less than 5.0%.

10. The additive for a cement composition according to claim 1, further comprising a sulfonic acid-based dispersant, a retarder or both.

11. A cement composition, comprising the additive of claim 1 and a cement.

12. A residential exterior wall material, comprising the cement composition according to claim 11.
